(19) United States
(12) Patent Application Publication
(10) Pub. No.: US 2021/0197120 A1
(43) Pub. Date: Jul. 1, 2021

(54) COMPRESSION APPARATUS

(71) Applicant: Panasonic Intellectual Propertty Management Co., Ltd., Osaka (JP)

(72) Inventors: YUKIMUNE KANI, Osaka (JP); KUNIHIRO UKAI, Nara (JP)

(21) Appl. No.: 17/199,502

(22) Filed: Mar. 12, 2021

Related U.S. Application Data
(63) Continuation of application No. PCT/JP2020/024752, filed on Jun. 24, 2020.

(30) Foreign Application Priority Data
Jul. 24, 2019 (JP) 2019-136246

(51) Int. Cl. B01D 53/26; B01D 53/22

(52) U.S. Cl. CPC B01D 53/268; B01D 53/228; B01D 2256/16; B01D 2257/80; B01D 2053/222

(57) ABSTRACT

A compression apparatus includes a compressor including an anode gas diffusion layer, an anode catalyst layer, an electrolyte membrane, a cathode catalyst layer, and a cathode gas diffusion layer that are stacked in this order, and a voltage applicator that applies a voltage between the catalyst layers, in which application of the voltage by the voltage applicator causes movement of, through the electrolyte membrane onto the cathode catalyst layer, a proton extracted from an anode fluid supplied onto the anode catalyst layer, to produce compressed hydrogen, and a remover that includes a water-permeable membrane, a first flow path through which a cathode gas from the compressor flows, and a second flow path through which a low-pressure gas flows. The remover removes water vapor and/or liquid water in the cathode gas flowing through the first flow path. The compressor and the remover are provided as a single body.

### BACKGROUND

### 1. Technical Field

The present disclosure relates to a compression apparatus.

### 2. Description of the Related Art

In recent years, due to environmental issues, such as global warming, and energy issues, such as depletion of petroleum resources, hydrogen has attracted attention as a clean alternative energy source that replaces fossil fuels. Hydrogen basically releases only water even when burnt, does not discharge carbon dioxide, which is responsible for global warming, and hardly discharges nitrogen oxides and the like. Therefore, hydrogen is expected as clean energy. In addition, as apparatuses that utilize hydrogen as a fuel at high efficiency, for example, fuel cells are known and are being developed and widely spread as power supplies for automobiles and private power generation for household use.

In the coming hydrogen society, technological development has been desired such that, in addition to the production of hydrogen, hydrogen can be stored at a high density and can be transported or utilized in a small volume and at a low cost. In particular, to promote the spread of fuel cells used as distributed energy sources, it is necessary to develop fuel supply infrastructure.

In view of this, to stably supply hydrogen in the fuel supply infrastructure, various proposals for purifying and compressing high-purity hydrogen have been made.

For example, Japanese Unexamined Patent Application Publication No. 2009-179842 discloses a water electrolytic device that produces high-pressure hydrogen while conducting electrolysis of water. Here, hydrogen produced by water electrolysis contains water vapor. Accordingly, in the storage of such hydrogen in a hydrogen reservoir such as a tank, if the hydrogen contains water vapor in a large amount, the amount of hydrogen in the hydrogen reservoir is decreased due to the presence of the water vapor in the hydrogen reservoir, resulting in a reduction in efficiency. There is also a problem of condensation of water vapor contained in hydrogen in the hydrogen reservoir. Therefore, the amount of water vapor in hydrogen in the case of storage in a hydrogen reservoir is desirably decreased to, for example, about less than or equal to 5 ppm. In view of this, Japanese Unexamined Patent Application Publication No. 2009-179842 proposes a hydrogen production system including, on a passage through which hydrogen flows and which is located between a water electrolytic device and a hydrogen reservoir, a gas-liquid separator that separates hydrogen and liquid water from each other and an adsorption tower that removes water vapor from hydrogen by adsorption.

In addition, for example, Japanese Unexamined Patent Application Publication (Translation of PCT Application) No. 2017-534435 proposes a system for stably removing water vapor in hydrogen with an adsorption tower that removes water vapor in high-pressure hydrogen by adsorption, the adsorption tower being configured as a pressure swing adsorption purifier (PSA).

### SUMMARY

One non-limiting and exemplary embodiment provides a compression apparatus in which a remover that removes at least one of water vapor or liquid water in a cathode gas containing hydrogen compressed in a compressor can be constituted more simply than in the related art.

In one general aspect, the techniques disclosed here feature a compression apparatus including a compressor that includes an electrolyte membrane, an anode catalyst layer disposed on a first main surface of the electrolyte membrane, a cathode catalyst layer disposed on a second main surface of the electrolyte membrane, an anode gas diffusion layer disposed on the anode catalyst layer, a cathode gas diffusion layer disposed on the cathode catalyst layer, and a voltage applicator that applies a voltage between the anode catalyst layer and the cathode catalyst layer, in which application of the voltage by the voltage applicator causes movement of, through the electrolyte membrane onto the cathode catalyst layer, a proton extracted from an anode fluid that has been supplied onto the anode catalyst layer, to produce compressed hydrogen; and a remover that includes a water-permeable membrane, a first flow path which is disposed on a first main surface of the water-permeable membrane and through which a cathode gas discharged from the compressor flows, and a second flow path which is disposed on a second main surface of the water-permeable membrane and through which a gas at a lower pressure than the cathode gas flows. The remover removes at least one of water vapor or liquid water contained in the cathode gas flowing through the first flow path. The compressor and the remover are provided as a single body.

The compression apparatus according to one aspect of the present disclosure is advantageous in that a remover that removes at least one of water vapor or liquid water in a cathode gas containing hydrogen compressed in a compressor can be constituted more simply than in the related art.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a view illustrating an example of a compression apparatus according to a first embodiment;

FIG. 1B is an enlarged view of portion IB of the compression apparatus in FIG. 1A;

FIG. 2 is a view illustrating an example of a compression apparatus in First Example according to the first embodiment;

FIG. 3 is a view illustrating an example of a compression apparatus in Second Example according to the first embodiment;

FIG. 4 is a view illustrating an example of a compression apparatus according to a second embodiment; and

FIG. 5 is a view illustrating an example of a compression apparatus according to a third embodiment.

### DETAILED DESCRIPTION

In a compressor, for example, an electrochemical hydrogen pump, using a solid polymer electrolyte membrane (hereinafter, referred to as an electrolyte membrane), hydrogen contained as a constituent element in a substance in an anode fluid, such as a hydrogen-containing gas, to be supplied to the anode is converted to protons, the protons are moved to the cathode, the protons (H⁺) are converted to hydrogen (H₂) at the cathode, and compressed hydrogen is thereby produced. In general, in this case, the proton conductivity of the electrolyte membrane increases under a condition of high temperature and high humidity (for example, the temperature and the dew point of the hydrogen-containing gas to be supplied to the electrolyte membrane are about 60° C.), and the efficiency of the hydrogen compression operation of the electrochemical hydrogen pump is improved. In contrast to this, when a high-pressure hydrogen-containing gas (hereinafter, referred to as a cathode gas) discharged from the cathode of the electrochemical hydrogen pump is stored in a hydrogen reservoir, the amount of water vapor in the cathode gas is desired to be decreased. However, efficient removal of such water vapor in the cathode gas is difficult in many cases.

For example, as in the adsorption tower disclosed in Japanese Unexamined Patent Application Publication No. 2009-179842 and Japanese Unexamined Patent Application Publication (Translation of PCT Application) No. 2017-534435, water vapor in hydrogen can be adsorbed by a porous adsorbent such as zeolite. However, there is a limitation in the adsorption performance of the adsorbent. The operation time of an adsorption tower depends on the amount of water supplied to the adsorption tower. Therefore, when an adsorption tower is used under the conditions for hydrogen containing water vapor in a large amount, it is necessary to increase the size of the adsorption tower. Furthermore, since high-pressure hydrogen flows through an adsorption tower, a vessel of the adsorption tower needs to be configured to withstand high pressure, which may result in a further increase in the size of the adsorption tower. As described in Japanese Unexamined Patent Application Publication (Translation of PCT Application) No. 2017-534435, the use of a pressure swing adsorption purifier enables a reduction in the loading amount of adsorbent. In this case, however, there may be problems in that, for example, a member constituting the flow path through which hydrogen flows becomes complicated, and, during regeneration of an adsorbent, it is necessary to treat hydrogen adsorbed on the adsorbent together with water vapor. Thus, there is room for improvement.

Accordingly, the inventors of the present disclosure have conducted extensive studies as described below, and as a result, have found that at least one of water vapor or liquid water in a cathode gas discharged from the cathode of a compressor can be efficiently removed from the cathode gas by using a water-permeable membrane. Incidentally, Japanese Unexamined Patent Application Publication No. 2009-179842 proposes that liquid water in hydrogen discharged from a water electrolytic device is separated from hydrogen by a gas-liquid separator, however, providing the above water-permeable membrane in the gas-liquid separator is not investigated.

Specifically, a compression apparatus according to a first aspect of the present disclosure includes a compressor that includes an electrolyte membrane, an anode catalyst layer disposed on a first main surface of the electrolyte membrane, a cathode catalyst layer disposed on a second main surface of the electrolyte membrane, an anode gas diffusion layer disposed on the anode catalyst layer, a cathode gas diffusion layer disposed on the cathode catalyst layer, and a voltage applicator that applies a voltage between the anode catalyst layer and the cathode catalyst layer, in which application of the voltage by the voltage applicator causes movement of, through the electrolyte membrane onto the cathode catalyst layer, a proton extracted from an anode fluid that has been supplied onto the anode catalyst layer, to produce compressed hydrogen; and

a remover that includes a water-permeable membrane, a first flow path which is disposed on a first main surface of the water-permeable membrane and through which a cathode gas discharged from the compressor flows, and a second flow path which is disposed on a second main surface of the water-permeable membrane and through which a gas at a lower pressure than the cathode gas flows. The remover removes at least one of water vapor or liquid water contained in the cathode gas flowing through the first flow path,

in which the compressor and the remover are provided as a single body.

With this configuration, the compression apparatus according to this aspect can constitute a remover that removes at least one of water vapor or liquid water in the cathode gas containing hydrogen compressed in the compressor more simply than in the related art.

Specifically, in the compression apparatus according to this aspect, the apparatus configuration can be simplified by providing the compressor and the remover as a single body.

For example, a high-pressure cathode gas flows through the compressor and the remover. Accordingly, if the compressor and the remover are provided separately from each other, a pair of highly rigid end plates for fixing the compressor and the remover from the top and the bottom, respectively, is necessary in many cases. In view of this, in the compression apparatus according to this aspect, since the compressor and the remover are provided as a single body, for example, end plates used for the compressor and the remover can be used in common. Therefore, the apparatus configuration can be simplified.

According to a compression apparatus according to a second aspect of the present disclosure, in the compression apparatus according to the first aspect, a first porous member may be disposed in the first flow path.

Unless the first porous member is disposed in the first flow path of the remover, the flow of the cathode gas in this first flow path tends to be a laminar flow. In this case, at least one of water vapor or liquid water in the cathode gas flows together with the cathode gas. Therefore, for example, at least one of water vapor or liquid water in the cathode gas present at a position apart from the water-permeable membrane is less likely to come in contact with the water-permeable membrane. That is, in this case, at least one of water vapor or liquid water that passes through the water-permeable membrane may be limited to at least one of water vapor or liquid water in the cathode gas flowing near the main surface of the water-permeable membrane.

In contrast, in the compression apparatus according to this aspect, the first porous member disposed in the first flow path can forcibly change the flow of the cathode gas in the first flow path in random directions. In this case, at least one of water vapor or liquid water in the cathode gas present at various positions in the first flow path can come in contact with the water-permeable membrane. Thus, in the compression apparatus according to this aspect, at least one of water vapor or liquid water in the cathode gas is more likely to come in contact with the water-permeable membrane than the case where the first porous member is not disposed in the first flow path. When at least one of water vapor or liquid water in the cathode gas comes in contact with the water-permeable membrane, at least one of high-pressure water vapor or liquid water that comes in contact with the water-permeable membrane can be efficiently passed into the low-pressure gas through the water-permeable membrane by the differential pressure between the first flow path (high pressure) and the second flow path (low pressure) of the remover. This enables the removal of at least one of water vapor or liquid water in the cathode gas to be accelerated in the remover.

According to a compression apparatus according to a third aspect of the present disclosure, in the compression apparatus according to the first or second aspect, a second porous member may be disposed in the second flow path.

Unless the second porous member is disposed in the second flow path of the remover, the water-permeable membrane is deformed by the differential pressure between the first flow path (high pressure) and the second flow path (low pressure) of the remover in a direction in which the second flow path is clogged. For example, such a differential pressure may cause the water-permeable membrane to come in contact with a member of the remover, the member constituting the second flow path. Consequently, the flow of the gas in the second flow path may become difficult. However, this problem is alleviated in the compression apparatus according to this aspect because the second porous member is disposed in the second flow path. The water that has passed through the water-permeable membrane can be efficiently drained, through pores of the second porous member, to the outside of the remover together with the gas in the second flow path.

According to a compression apparatus according to a fourth aspect of the present disclosure, the first porous member in the compression apparatus according to the second aspect may include the cathode gas diffusion layer.

According to a compression apparatus according to a fifth aspect of the present disclosure, the second porous member in the compression apparatus according to the third aspect may include the anode gas diffusion layer.

According to a compression apparatus according to a sixth aspect of the present disclosure, in the remover in the compression apparatus according to any one of the first to fifth aspects, the first flow path may be disposed so as to be located above the second flow path.

With this configuration, in the compression apparatus according to this aspect, liquid water in the cathode gas that flows through the first flow path moves from the top to the bottom by the action of gravity, and thus the liquid water and the water-permeable membrane easily come in contact with each other. Therefore, in the compression apparatus according to this aspect, the removal of the liquid water in the cathode gas can be accelerated in the remover compared with the case where the vertical positional relationship between the first flow path and the second flow path is reversed.

According to a compression apparatus according to a seventh aspect of the present disclosure, the remover in the compression apparatus according to any one of the first to sixth aspects may be disposed on a bottom side of the compressor.

During the passage of a gas through the second flow path of the remover, this gas is humidified by at least one of water vapor or liquid water in the cathode gas that has passed through the water-permeable membrane. Therefore, if the remover is disposed on the top side of the compressor, it is difficult to provide an outlet of a low-pressure gas at the bottom surface of the remover. Unless the outlet of the low-pressure gas is provided at the bottom surface of the remover, liquid water in the low-pressure gas in the second flow path is unlikely to be smoothly drained, and a pipe through which the low-pressure gas flows may be dogged with liquid water.

However, in the compression apparatus according to this aspect, since the remover is disposed on the bottom side of the compressor, the outlet of the low-pressure gas is easily provided at the bottom surface of the remover. When the outlet of the low-pressure gas is provided at the bottom surface of the remover, in the compression apparatus according to this aspect, liquid water in the low-pressure gas in the second flow path can be smoothly drained by the action of gravity.

According to a compression apparatus according to an eighth aspect of the present disclosure, the compression apparatus according to any one of the first to seventh aspects may include a heat-insulating member between the compressor and the remover.

In the compressor, the proton conductivity of the electrolyte membrane increases under a condition of high temperature and high humidity (for example, the temperature and the dew point of a hydrogen-containing gas to be supplied to the electrolyte membrane are about 60° C.), and the efficiency of the hydrogen compression operation of the compressor is improved.

In contrast, in the remover, for example, the temperature of the low-temperature gas flowing into the second flow path of the remover is made lower than the temperature of the cathode gas flowing into the first flow path of the remover. Consequently, when the cathode gas passes through the first flow path, the cathode gas is appropriately cooled by heat exchange through the water-permeable membrane between the two gases. Thus, high-pressure condensed water produced by condensation of water vapor in the cathode gas can be efficiently passed into the low-pressure gas through the water-permeable membrane by the differential pressure between the first flow path (high pressure) and the second flow path (low pressure).

In the compression apparatus described above, if the compressor and the remover are provided as a single body without disposing the heat-insulating member between the compressor and the remover, the temperature of the compressor may become lower than a desired temperature due to heat exchange between the compressor and the remover. Alternatively, the temperature of the remover may become higher than a desired temperature due to heat exchange between the compressor and the remover.

In view of the above, in the compression apparatus according to this aspect, the disadvantages described above can be reduced by disposing the heat-insulating member between the compressor and the remover.

According to a compression apparatus according to a ninth aspect of the present disclosure, the gas at the lower pressure in the compression apparatus according to any one of the first to eighth aspects may be a hydrogen-containing gas.

According to this configuration, in the compression apparatus according to this aspect, when a hydrogen-containing gas that flows out from the second flow path of the remover is supplied to the anode of the compressor, the hydrogen-containing gas can be humidified in the remover.

According to a compression apparatus according to a tenth aspect of the present disclosure, the compression apparatus according to any one of the first to ninth aspects may include a cooler that cools the cathode gas flowing through the first flow path.

According to this configuration, in the compression apparatus according to this aspect, the removal of water vapor in the cathode gas can be accelerated by cooling the cathode gas in the remover with the cooler. For example, the amount of saturated water vapor contained in the cathode gas decreases with the decrease in the temperature of the cathode gas. Therefore, when the amount of water vapor in the cathode gas is the amount of saturated water vapor, a decrease in the temperature of the cathode gas with the cooler enables a rapid decrease in the amount of water vapor in the cathode gas. This enables the removal of water vapor in the cathode gas to be accelerated. In this case, since the amount of liquid water present in the remover increases, the liquid water is more likely to come in contact with the water-permeable membrane. When the liquid water comes in contact with the water-permeable membrane, the high-pressure liquid water that comes in contact with the water-permeable membrane can be efficiently passed into the low-pressure gas through the water-permeable membrane by the differential pressure between the first flow path (high pressure) and the second flow path (low pressure) of the remover.

According to a compression apparatus according to an eleventh aspect of the present disclosure, the remover in the compression apparatus according to any one of the first to tenth aspects may be stacked with respect to the compressor in the same direction as a direction in which the anode gas diffusion layer, the anode catalyst layer, the electrolyte membrane, the cathode catalyst layer, and the cathode gas diffusion layer in the compressor are stacked.

According to this configuration, in the compression apparatus according to this aspect, a remover that removes at least one of water vapor or liquid water in the cathode gas containing hydrogen compressed in a compressor can be constituted more simply than in the related art. The details of the operation and effect of the compression apparatus according to this aspect are the same as the details of the operation and effect of the compression apparatus according to the first aspect, and a description thereof is omitted.

Specific examples of the aspects of the present disclosure will be described below with reference to the accompanying drawings. The specific examples described below are examples of the above aspects. Therefore, for example, the shapes, materials, components, and arrangements and connection forms of the components described below do not limit the aspects unless otherwise specified in the claims. Among the components described below, components that are not described in the independent claim defining the broadest concept of the present aspects are described as optional components. In the drawings, a description of components denoted by the same reference numerals may be omitted as appropriate, The drawings schematically illustrate components for the sake of ease of understanding, and their shapes, dimension ratios, etc. may not be accurately illustrated.

### First Embodiment

The anode fluid of the compressor is assumed to be any of various types of gases and liquids as long as the fluid produces protons in the oxidation reaction in the anode. The anode fluid may be, for example, a hydrogen-containing gas or liquid water. For example, when the compressor is an electrochemical hydrogen pump, the anode fluid may be a hydrogen-containing gas or the like. For example, when the compressor is a water electrolytic device, the anode fluid may be liquid water or the like. When the anode fluid is liquid water, an electrolysis reaction of the liquid water is carried out on an anode catalyst layer. Accordingly, in embodiments described below, a description will be made of the configurations and operations of an electrochemical hydrogen pump, which is an example of the compressor, and a compression apparatus including the compressor in the case where the anode fluid is a hydrogen-containing gas.

### Apparatus Configuration

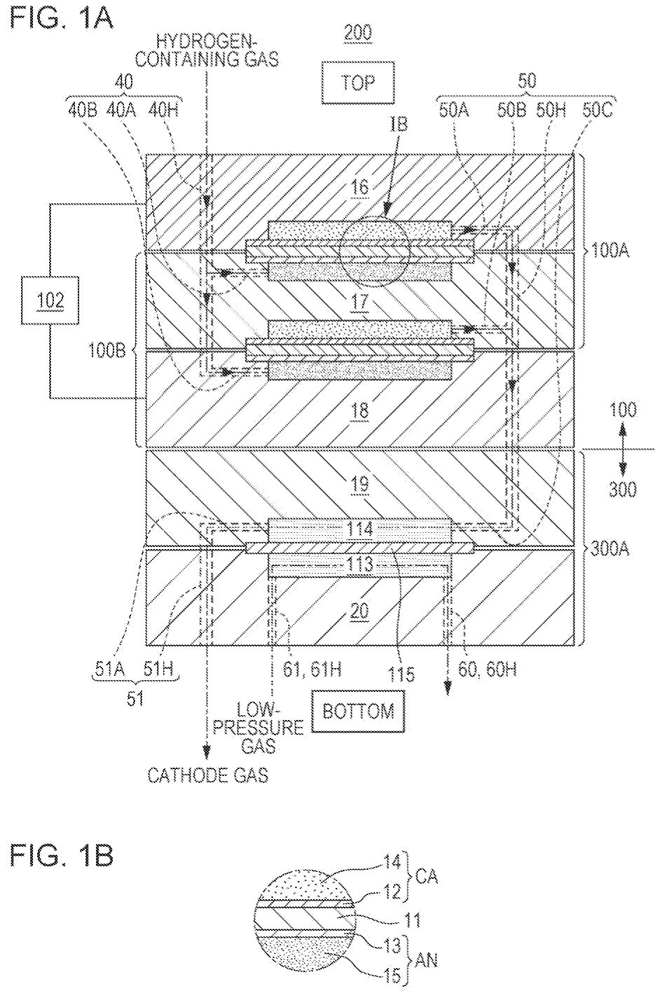

FIG. 1A is a view illustrating an example of a compression apparatus according to a first embodiment. FIG. 1B is an enlarged view of portion IB of the compression apparatus in FIG. 1A.

It is assumed that a “top” and a “bottom” in a vertical direction of a compression apparatus 200 are defined as illustrated in FIG. 1A and that the gravity acts from the “top” to the “bottom” (this also applies to other figures).

In the example illustrated in FIGS. 1A and 1B, the compression apparatus 200 includes an electrochemical hydrogen pump 100, a remover 300, and a voltage applicator 102.

Here, members of the electrochemical hydrogen pump 100 and members of the remover 300 are disposed so as to be stacked in the vertical direction, and the electrochemical hydrogen pump 100 is located on the top side with respect to the remover 300 in the vertical direction.

Configurations and other features of equipment of the compression apparatus 200 will be described in detail below with reference to the drawings.

### Configuration of Electrochemical Hydrogen Pump

As illustrated in FIG. 1A, the compression apparatus 200 includes a hydrogen pump unit 100A and a hydrogen pump unit 100B of the electrochemical hydrogen pump 100. Note that the hydrogen pump unit 100A is located on the top side with respect to the hydrogen pump unit 100B.

In this example, two hydrogen pump units, i.e., the hydrogen pump unit 100A and the hydrogen pump unit 100B are illustrated. However, the number of hydrogen pump units is not limited to this example. Specifically, the number of hydrogen pump units can be appropriately determined on the basis of, for example, the operation conditions such as the amount of hydrogen to be compressed at a cathode CA of the electrochemical hydrogen pump 100.

The hydrogen pump unit 100A includes an electrolyte membrane 11, and anode AN, a cathode CA, a cathode separator 16, and an intermediate separator 17. The hydrogen pump unit 100B includes an electrolyte membrane 11, an anode AN, a cathode CA, the intermediate separator 17, and an anode separator 18. Specifically, the intermediate separator 17 functions as an anode separator of the hydrogen pump unit 100A, also functions as a cathode separator of the hydrogen pump unit 100B, and thus is used in the hydrogen pump unit 100A and the hydrogen pump unit 100B in common.

The stack configuration of the hydrogen pump unit 100A will be described in more detail below. The stack configuration of the hydrogen pump unit 100B is the same as that of the hydrogen pump unit 100A, and a description thereof may be omitted.

As illustrated in FIG. 1B, the anode AN is disposed on one main surface of the electrolyte membrane 11. The anode AN is an electrode including an anode catalyst layer 13 and an anode gas diffusion layer 15.

In general, in the electrochemical hydrogen pump 100, a catalyst coated membrane CCM in which an anode catalyst layer 13 and a cathode catalyst layer 12 are assembled to an electrolyte membrane 11 as a single component is often used. Accordingly, when the catalyst coated membrane CCM is used as the electrolyte membrane 11, the anode gas diffusion layer 15 is disposed on the main surface of the anode catalyst layer 13 that is assembled to the catalyst coated membrane CCM.

As illustrated in FIG. 1B, the cathode CA is disposed on the other main surface of the electrolyte membrane 11. The cathode CA is an electrode including a cathode catalyst layer 12 and a cathode gas diffusion layer 14. When the catalyst coated membrane CCM is used as the electrolyte membrane 11, the cathode gas diffusion layer 14 is disposed on the main surface of the cathode catalyst layer 12 that is assembled to the catalyst coated membrane CCM.

Thus, in the hydrogen pump unit 100A and the hydrogen pump unit 100B, the electrolyte membrane 11 is held between the anode AN and the cathode CA such that the anode catalyst layer 13 and the cathode catalyst layer 12 are in contact with the electrolyte membrane 11. A cell including the cathode CA, the electrolyte membrane 11, and the anode AN is hereinafter referred to as a membrane electrode assembly (MEA).

An insulator and a sealing member (not illustrated) each having an annular and flat shape are disposed between the cathode separator 16 and the intermediate separator 17 and between the intermediate separator 17 and the anode separator 18 so as to surround the periphery of the MEA in plan view. This prevents a short circuit between the cathode separator 16 and the intermediate separator 17 and a short circuit between the intermediate separator 17 and the anode separator 18.

The electrolyte membrane 11 has proton conductivity. The electrolyte membrane 11 may have any configuration as long as the electrolyte membrane 11 has proton conductivity. Examples of the electrolyte membrane 11 include, but are not limited to, fluorinated polymer electrolyte membranes and hydrocarbon polymer electrolyte membranes. Specifically, for example, Nafion (registered trademark, manufactured by DuPont) or Aciplex (registered trademark, manufactured by Asahi Kasei Corporation) can be used as the electrolyte membrane 11.

The anode catalyst layer 13 is disposed on one main surface of the electrolyte membrane 11. The anode catalyst layer 13 includes, for example, platinum as a catalytic metal, but the catalytic metal is not limited to this.

The cathode catalyst layer 12 is disposed on the other main surface of the electrolyte membrane 11. The cathode catalyst layer 12 includes, for example, platinum as a catalytic metal, but the catalytic metal is not limited to this.

Examples of a catalyst support for the cathode catalyst layer 12 and the anode catalyst layer 13 include, but are not limited to, carbon powders such as carbon black and graphite, and electrically conductive oxide powders.

In the cathode catalyst layer 12 and the anode catalyst layer 13, fine particles of a catalytic metal are supported on the catalyst support in a highly dispersed manner. A proton-conductive ionomer component is typically added to the cathode catalyst layer 12 and the anode catalyst layer 13 in order to increase the electrode reaction field.

The cathode gas diffusion layer 14 is disposed on the cathode catalyst layer 12. The cathode gas diffusion layer 14 is composed of a porous material and has electrical conductivity and gas diffusivity. Furthermore, the cathode gas diffusion layer 14 desirably has elasticity so as to appropriately follow the displacement or deformation of a component member caused by the differential pressure between the cathode CA and the anode AN during the operation of the electrochemical hydrogen pump 100, In the electrochemical hydrogen pump 100 of this embodiment, a member composed of carbon fibers is used as the cathode gas diffusion layer 14, The cathode gas diffusion layer 14 may be formed of, for example, a porous carbon fiber sheet such as carbon paper, carbon cloth, or carbon felt. The substrate of the cathode gas diffusion layer 14 is not necessarily a carbon fiber sheet. For example, the substrate of the cathode gas diffusion layer 14 may be a sintered body of metal fibers composed of a material such as titanium, a titanium alloy, or stainless steel, or a sintered body of a metal powder composed of any of these materials.

The anode gas diffusion layer 15 is disposed on the anode catalyst layer 13. The anode gas diffusion layer 15 is composed of a porous material and has electrical conductivity and gas diffusivity. Furthermore, the anode gas diffusion layer 15 desirably has high rigidity and can reduce the displacement or deformation of a component member caused by the differential pressure between the cathode CA and the anode AN during the operation of the electrochemical hydrogen pump 100.

In the electrochemical hydrogen pump 100 of this embodiment, a member composed of a thin sheet of a titanium powder sintered body is used as the anode gas diffusion layer 15. However, the member is not limited to this. Specifically, the substrate of the anode gas diffusion layer 15 may be a sintered body of metal fibers composed of a material such as titanium, a titanium alloy, or stainless steel, or a sintered body of a metal powder composed of any of these materials. A carbon porous body may also be used. The substrate of the anode gas diffusion layer 15 may also be formed of, for example, expanded metal, a metal mesh, or perforated metal.

The anode separator 18 is a conductive member disposed on the anode gas diffusion layer 15 of the anode AN of the hydrogen pump unit 100B. The cathode separator 16 is a conductive member disposed on the cathode gas diffusion layer 14 of the cathode CA of the hydrogen pump unit 100A. The intermediate separator 17 is a conductive member disposed on the anode gas diffusion layer 15 of the anode AN of the hydrogen pump unit 100A and on the cathode gas diffusion layer 14 of the cathode CA of the hydrogen pump unit 100B. The cathode separator 16, the intermediate separator 17, and the anode separator 18 may each be composed of, for example, a metal such as titanium or SUS316L but are not limited to this.

The cathode separator 16 has a recess at a central portion in a main surface thereof. The cathode CA of the hydrogen pump unit 100A and a portion of the electrolyte membrane 11 of the hydrogen pump unit 100A in the thickness direction are accommodated in this recess.

The anode separator 18 has a recess at a central portion in a main surface thereof. The anode AN of the hydrogen pump unit 100B and a portion of the electrolyte membrane 11 of the hydrogen pump unit 100B in the thickness direction are accommodated in this recess.

The intermediate separator 17 has a recess at a central portion in each of the main surfaces thereof. The anode AN of the hydrogen pump unit 100A and a portion of the electrolyte membrane 11 of the hydrogen pump unit 100A in the thickness direction are accommodated in one of these recesses. The cathode CA of the hydrogen pump unit 100B and a portion of the electrolyte membrane 11 of the hydrogen pump unit 100B in the thickness direction are accommodated in the other recess.

In this manner, the hydrogen pump unit 100A is formed by the cathode separator 16, the intermediate separator 17, and the MEA disposed therebetween. The hydrogen pump unit 100B is formed by the anode separator 18, the intermediate separator 17, and the MEA disposed therebetween.

For example, a serpentine-shaped anode gas flow path (not illustrated) including a plurality of U-shaped folding portions and a plurality of linear portions in plan view may be provided in the main surface of the intermediate separator 17 in contact with the anode gas diffusion layer 15 and in the main surface of the anode separator 18 in contact with the anode gas diffusion layer 15. However, such an anode gas flow path is an example, and the present disclosure is not limited thereto. For example, the anode gas flow path may be formed by a plurality of linear flow paths.

As illustrated in FIG. 1A, the compression apparatus 200 includes the voltage applicator 102.

The voltage applicator 102 is a device that applies a voltage between the anode catalyst layer 13 and the cathode catalyst layer 12. Specifically, a high potential of the voltage applicator 102 is applied to the anode catalyst layer 13, and a low potential of the voltage applicator 102 is applied to the cathode catalyst layer 12. The voltage applicator 102 may have any configuration as long as the voltage applicator 102 can apply a voltage between the anode catalyst layer 13 and the cathode catalyst layer 12. For example, the voltage applicator 102 may be a device that adjusts the voltage applied between the anode catalyst layer 13 and the cathode catalyst layer 12. Specifically, the voltage applicator 102 includes a DC/DC converter when connected to a direct-current power supply such as a battery, a solar cell, or a fuel cell, or includes an AC/DC converter when connected to an alternating-current power supply such as a commercial power supply.

The voltage applicator 102 may be, for example, an electric power-type power supply in which the voltage applied between the anode catalyst layer 13 and the cathode catalyst layer 12 and the electric current flowing between the anode catalyst layer 13 and the cathode catalyst layer 12 are adjusted such that the power supplied to the electrochemical hydrogen pump 100 is controlled to a predetermined set value.

Although not illustrated, a low-potential terminal of the voltage applicator 102 is connected to a cathode feed plate, and a high-potential terminal of the voltage applicator 102 is connected to an anode feed plate. The cathode feed plate is disposed on, for example, the cathode separator 16 of the hydrogen pump unit 100A. The anode feed plate is disposed on, for example, the anode separator 18 of the hydrogen pump unit 100B. The cathode feed plate and the anode feed plate are in electrical contact with the cathode separator 16 and the anode separator 18, respectively.

As described above, the electrochemical hydrogen pump 100 is a device in which protons extracted, by the voltage applied by the voltage applicator 102, from an anode fluid that is supplied onto the anode catalyst layer 13 are moved onto the cathode catalyst layer 12 through the electrolyte membrane 11 to produce compressed hydrogen. Specifically, in the electrochemical hydrogen pump 100, protons (H⁺) extracted from a hydrogen-containing gas in the anode AN move to the cathode CA through the electrolyte membrane 11, and a cathode gas is thereby produced in the cathode CA. The cathode gas is, for example, a high-pressure hydrogen-containing gas that contains water vapor discharged from the cathode CA.

The electrochemical hydrogen pump 100 is provided with an anode gas supply passage 40 through which a hydrogen-containing gas is supplied from the outside to the anodes AN, and a cathode gas flow passage 50 through which a cathode gas is sent from the cathodes CA to the remover 300. The detailed configurations of these passages will be described later.

### Configuration of Remover

As illustrated in FIG. 1A, the compression apparatus 200 includes a removal unit 300A of the remover 300. A single removal unit 300A is illustrated in the remover 300. However, the number of removal units 300A is not limited to this example.

The removal unit 300A includes a water-permeable membrane 115, a first flow path, a second flow path, a first plate 19, and a second plate 20.

The first flow path is a flow path (hereinafter, referred to as a cathode gas flow path 114) which is disposed on one main surface of the water-permeable membrane 115 and through which a cathode gas discharged from the cathodes CA of the electrochemical hydrogen pump 100 flows. Specifically, a high-pressure cathode gas flows through the cathode gas flow path 114 while in contact with one main surface of the water-permeable membrane 115. The second flow path is a flow path (hereinafter, referred to as a low-pressure gas flow path 113) which is disposed on the other main surface of the water-permeable membrane 115 and through which a gas at a lower pressure than the cathode gas flows. Specifically, a gas at a lower pressure than the cathode gas flows through the low-pressure gas flow path 113 while in contact with the other main surface of the water-permeable membrane 115. The details of the low-pressure gas will be described in Examples.

The water-permeable membrane 115 may have any configuration as long as the water-permeable membrane 115 has low permeability to hydrogen (H₂) in the cathode gas and is permeable to at least one of water vapor or liquid water in the cathode gas. For example, the water-permeable membrane 115 may be a membrane composed of a polymer having a sulfonate group. With this configuration, the water-permeable membrane 115 can be provided with a function of allowing at least one of water vapor or liquid water in the cathode gas to pass therethrough. The water-permeable membrane 115 may be, for example, a proton-conductive polymer membrane that is composed of a material similar to that of the electrolyte membrane 11 and that is permeable to protons (H⁺). Specifically, examples of the water-permeable membrane 115 include, but are not limited to, fluorinated polymer membranes and hydrocarbon polymer membranes that can be used as proton-conductive polymer membranes.

The first plate 19 and the second plate 20 each have a recess at a central portion in a main surface thereof. A portion of the water-permeable membrane 115 in the thickness direction is accommodated in each of the recesses. Specifically, the cathode gas flow path 114 corresponds to a region partitioned by the recess provided in the first plate 19 and the water-permeable membrane 115. The low-pressure gas flow path 113 corresponds to a region partitioned by the recess provided in the second plate 20 and the water-permeable membrane 115. The first plate 19 and the second plate 20 may be composed of, for example, titanium metal but are not limited to this.

An annular and flat-shaped sealing member (not illustrated) is disposed between the first plate 19 and the second plate 20 so as to surround the periphery of the water-permeable membrane 115 in plan view.

The remover 300 has the cathode gas flow passage 50 through which the cathode gas is sent from the cathodes CA of the electrochemical hydrogen pump 100 to the cathode gas flow path 114, a cathode gas discharge passage 51 through which the cathode gas is discharged from the cathode gas flow path 114 to the outside, a low-pressure gas supply passage 61 through which a gas is supplied from the outside to the low-pressure gas flow path 113, and a low-pressure gas discharge passage 60 through which the gas is discharged from the low-pressure gas flow path 113 to the outside. The details of these passages will be described later.

### Fastening Configuration of Electrochemical Hydrogen Pump and Remover

As illustrated in FIGS. 1A and 1B, the remover 300 is stacked with respect to the electrochemical hydrogen pump 100 in the same direction as a direction in which the anode gas diffusion layer 15, the anode catalyst layer 13, the electrolyte membrane 11, the cathode catalyst layer 12, and the cathode gas diffusion layer 14 in the electrochemical hydrogen pump 100 are stacked.

Although not illustrated, for example, a highly rigid first end plate is disposed on the outer surface of the cathode separator 16 of the electrochemical hydrogen pump 100 with a first insulating plate therebetween, Furthermore, for example, a highly rigid second end plate is disposed on the outer surface of the second plate 20 of the remover 300 with a second insulating plate therebetween.

A fastener (not illustrated) fastens the members of the electrochemical hydrogen pump 100 and the remover 300, the first insulating plate, the first end plate, the second insulating plate, and the second end plate in the stacking direction.

The fastener may have any configuration as long as the fastener can fasten such members in the stacking direction.

Examples of the fastener include bolts and nuts with a disc spring.

In this case, a bolt of the fastener may pass through only the first end plate and the second end plate. Alternatively, the bold may pass through the members of the electrochemical hydrogen pump 100 and the remover 300, the first insulating plate, the first end plate, the second insulating plate, and the second end plate. The fastener applies a desired fastening pressure to the electrochemical hydrogen pump 100 and the remover 300 such that an end face of the cathode separator 16 and an end face of the second plate 20 are sandwiched by the first end plate and the second end plate with the first insulating plate and the second insulating plate therebetween, respectively.

In the case where a bolt of the fastener is configured to pass through the members of the electrochemical hydrogen pump 100 and the remover 300, the first insulating plate, the first end plate, the second insulating plate, and the second end plate, the members of the electrochemical hydrogen pump 100 and the remover 300 are appropriately held in the stacking direction in the stacked state by the fastening pressure of the fastener, and the movement of the members of the electrochemical hydrogen pump 100 and the remover 300 in the in-plane direction can be appropriately reduced because the bolt of the fastener passes through these members.

As described above, in the compression apparatus 200 of this embodiment, the members of the electrochemical hydrogen pump 100 and the members of the remover 300 are stacked together by the fastener in the stacking direction to form a single body.

### Configuration of Flow Path of Hydrogen-Containing Gas

An example of the configuration of the flow path through which a hydrogen-containing gas is supplied to the anodes AN of the electrochemical hydrogen pump 100 will be described below with reference to FIG. 1A. In FIG. 1A, a schematic diagram of the flow of the hydrogen-containing gas is shown by the arrows of the thin dash-dot-dash line.

As illustrated in FIG. 1A, the compression apparatus 200 includes the anode gas supply passage 40.

The anode gas supply passage 40 is constituted by, for example, a series of a vertical flow path 40H provided at appropriate positions of the members of the electrochemical hydrogen pump 100 and extending in the vertical direction, and a first horizontal flow path 40A and a second horizontal flow path 403 that are provided at appropriate positions of the intermediate separator 17 and the anode separator 18, respectively, and that extend in the horizontal direction. Specifically, the vertical flow path 40H communicates with the anode AN of the hydrogen pump unit 100A through the first horizontal flow path 40A provided in the intermediate separator 17. For example, this first horizontal flow path 40A may be connected to an end portion of a serpentine-shaped anode gas flow path (not illustrated) provided in the intermediate separator 17. In addition, the vertical flow path 40H communicates the anode AN of the hydrogen pump unit 100B through the second horizontal flow path 40B provided in the anode separator 18. For example, this second horizontal flow path 40B may be connected to an end portion of a serpentine-shaped anode gas flow path (not illustrated) provided in the anode separator 18.

With the above configuration, the hydrogen-containing gas from the outside flows through the vertical flow path 40H, the first horizontal flow path 40A, and the anode AN of the hydrogen pump unit 100A in this order and flows through the vertical flow path 40H, the second horizontal flow path 40B, and the anode AN of the hydrogen pump unit 100B in this order, as shown by the arrows of the dash-dot-dash line in FIG. 1A. Specifically, the hydrogen-containing gas of the vertical flow path 40H is divided so as to flow through both the first horizontal flow path 40A and the second horizontal flow path 40B. When the hydrogen-containing gas is supplied to the electrolyte membranes 11 through the anode gas diffusion layers 15, compression of hydrogen in the hydrogen-containing gas is performed in the hydrogen pump unit 100A and the hydrogen pump unit 100B.

### Configuration of Flow Path of Cathode Gas

An example of the configuration of the flow path of a cathode gas in the electrochemical hydrogen pump 100 and the remover 300 will be described below with reference to FIG. 1A. In FIG. 1A, a schematic diagram of the flow of the cathode gas is shown by the arrows of the thin dash-dot-dash line.

As illustrated in FIG. 1A, the compression apparatus 200 has the cathode gas flow passage 50 and the cathode gas discharge passage 51.

The cathode gas flow passage 50 is constituted by, for example, a series of a vertical flow path 50H provided at appropriate positions of the members of the electrochemical hydrogen pump 100 and the remover 300 and extending in the vertical direction, and a first horizontal flow path 50A, a second horizontal flow path 50B, and a third horizontal flow path 50C that are provided at appropriate positions of the cathode separator 16, the intermediate separator 17, and the first plate 19, respectively, and that extend in the horizontal direction. Specifically, the vertical flow path 50H communicates with the cathode CA of the hydrogen pump unit 100A through the first horizontal flow path 50A provided in the cathode separator 16. The vertical flow path 50H communicates with the cathode CA of the hydrogen pump unit 100B through the second horizontal flow path 50B provided in the intermediate separator 17. Furthermore, the vertical flow path 50H communicates with the cathode gas flow path 114 of the removal unit 300A through the third horizontal flow path 50C provided in the first plate 19.

The cathode gas discharge passage 51 is constituted by, for example, a series of a vertical flow path 51H provided at appropriate positions of the members of the remover 300 and extending in the vertical direction, and a horizontal flow path 51A provided at an appropriate position of the first plate 19 and extending in the horizontal direction. Specifically, the vertical flow path 51H communicates with the cathode gas flow path 114 of the removal unit 300A through the horizontal flow path 51A provided in the first plate 19.

With the above configuration, the high-pressure cathode gas containing hydrogen compressed at the cathode CA of the hydrogen pump unit 100A flows through the first horizontal flow path 50A, the vertical flow path 50H, the third horizontal flow path 50C, the cathode gas flow path 114, the horizontal flow path 51A, and the vertical flow path 51H in this order, as shown by the arrows of the dash-dot-dash line in FIG. 1A. Subsequently, the cathode gas is discharged to the outside of the compression apparatus 200. The high-pressure cathode gas containing hydrogen compressed at the cathode CA of the hydrogen pump unit 100B flows through the second horizontal flow path 50B, the vertical flow path 50H, the third horizontal flow path 50C, the cathode gas flow path 114, the horizontal flow path 51A, and the vertical flow path 51H in this order, as shown by the arrow of the dash-dot-dash line in FIG. 1A. Subsequently, the cathode gas is discharged to the outside of the compression apparatus 200. Specifically, the two cathode gases in the first horizontal flow path 50A and the second horizontal flow path 50B join in the vertical flow path 50H and then flow through the third horizontal flow path 50C. In this case, when the cathode gas passes through the cathode gas flow path 114 of the removal unit 300A, the removal of at least one of water vapor or liquid water in the cathode gas is conducted in the removal unit 300A.

### Configuration of Flow Path of Low-Pressure Gas

An example of the configuration of the flow path of a low-pressure gas in the removal unit 300A will be described below with reference to FIG. 1A. In FIG. 1A, a schematic diagram of the flow of the low-pressure gas is shown by the arrow of the thin dash-dot-dash line.

As illustrated in FIG. 1A, the compression apparatus 200 has the low-pressure gas supply passage 61 and the low-pressure gas discharge passage 60.

The low-pressure gas supply passage 61 is constituted by, for example, a vertical flow path 61H provided at an appropriate position of the second plate 20 of the remover 300 and extending in the vertical direction so as to communicate between the outside and one end portion of the low-pressure gas flow path 113. The low-pressure gas discharge passage 60 is constituted by, for example, a vertical flow path 60H provided at an appropriate position of the second plate 20 of the remover 300 and extending in the vertical direction so as to communicate between the outside and the other end portion of the low-pressure gas flow path 113.

With the above configuration, the low-pressure gas from the outside flows through the low-pressure gas supply passage 61, the low-pressure gas flow path 113, and the low-pressure gas discharge passage 60 in this order, as shown by the arrow of the dash-dot-dash line in FIG. 1A. Subsequently, the low-pressure gas is discharged to the outside of the removal unit 300A.

The configurations of the electrochemical hydrogen pump 100 and the remover 300 described above are examples, and the present disclosure is not limited to these examples.

### Operation

An example of the operation of the compression apparatus 200 according to the first embodiment will be described below with reference to the drawings.

The following operation may be performed by, for example, an arithmetic circuit of a controller (not illustrated) by reading out a control program from a memory circuit of the controller. However, the following operation is not necessarily performed by a controller. An operator may perform part of the operation.

First, a low-pressure hydrogen-containing gas is supplied to each of the anodes AN of the electrochemical hydrogen pump 100, and a voltage of the voltage applicator 102 is applied to the electrochemical hydrogen pump 100. Consequently, in the electrochemical hydrogen pump 100, a hydrogen compression operation is performed in which protons extracted from the hydrogen-containing gas supplied to the anode AN move to the corresponding cathode CA through the electrolyte membrane 11, and compressed hydrogen is produced. Specifically, a hydrogen molecule is dissociated into protons and electrons in the anode catalyst layer 13 of the anode AN (formula (1)). The protons are conducted in the electrolyte membrane 11 and move to the cathode catalyst layer 12. The electrons move to the cathode catalyst layer 12 through the voltage applicator 102. A hydrogen molecule is then reproduced in the cathode catalyst layer 12 (formula (2)). It is known that when protons are conducted in the electrolyte membrane 11, a certain amount of water moves along with the protons from the anode AN to the cathode CA as electroosmotic water.

Anode: H₂ (low pressure)→2H⁺+2e⁻ (1)

Cathode: 2H⁺+2e⁻→H₂ (high pressure) (2)

Hydrogen produced in the cathode CA of the electrochemical hydrogen pump 100 is compressed as a cathode gas at the cathode CA. The cathode gas can be compressed at the cathode CA by, for example, increasing the pressure loss of a cathode gas outlet passage by using a flow controller (not illustrated). Examples of the flow controller include back-pressure valves and regulating valves provided in the cathode gas outlet passage.

When the pressure loss of the cathode gas outlet passage is decreased by using the flow controller in a timely manner, the cathode gas is sent from the cathode CA of the electrochemical hydrogen pump 100 to the remover 300 through the cathode gas flow passage 50. The phrase “decreasing the pressure loss of the cathode gas outlet passage by using the flow controller” means increasing the opening of the valve such as a back-pressure valve or a regulating valve.

Consequently, the cathode gas discharged from the cathode CA of the electrochemical hydrogen pump 100 flows through the cathode gas flow path 114 of the remover 300. Therefore, when liquid water is contained in the cathode gas, an operation of removing water in the cathode gas can be conducted by causing a gas at a lower pressure than the cathode gas to flow through the low-pressure gas flow path 113 of the remover 300. An operation of removing water vapor in the cathode gas can be conducted by causing a gas at a lower water vapor partial pressure than the cathode gas to flow through the low-pressure gas flow path 113 of the remover 300. In this case, the temperature of the gas flowing into the low-pressure gas flow path 113 of the remover 300 is preferably lower than the temperature of the cathode gas flowing into the cathode gas flow path 114 of the remover 300. This accelerates water condensation of the cathode gas flowing through the cathode gas flow path 114, and thus the removal of water vapor in the cathode gas is also accelerated.

As described above, the compression apparatus 200 of this embodiment can constitute the remover 300 that removes at least one of water vapor or liquid water in the cathode gas containing hydrogen compressed in the electrochemical hydrogen pump 100 more simply than in the related art. Specifically, in the compression apparatus 200 of this embodiment, the apparatus configuration can be simplified by providing the electrochemical hydrogen pump 100 and the remover 300 as a single body.

For example, a high-pressure cathode gas flows through the electrochemical hydrogen pump 100 and the remover 300. Accordingly, if the electrochemical hydrogen pump 100 and the remover 300 are provided separately from each other, a pair of highly rigid end plates for fixing the electrochemical hydrogen pump 100 and the remover 300 from the top and the bottom, respectively, is necessary in many cases. In view of this, in the compression apparatus 200 of this embodiment, since the electrochemical hydrogen pump 100 and the remover 300 are provided as a single body, for example, end plates used for the electrochemical hydrogen pump 100 and the remover 300 can be used in common. Therefore, the apparatus configuration can be simplified.

In the compression apparatus 200 of this embodiment, as illustrated in FIG. 1A, the cathode gas flow path 114 is disposed so as to be located above the low-pressure gas flow path 113 in the vertical direction of the compression apparatus 200. With this configuration, in the compression apparatus 200 of this embodiment, when condensed water in the cathode gas flowing through the cathode gas flow path 114 is produced, the condensed water moves from the top to the bottom by the action of gravity, and thus the condensed water and the water-permeable membrane 115 easily come in contact with each other. Therefore, in the compression apparatus 200 of this embodiment, the removal of the condensed water in the cathode gas can be accelerated in the remover 300 compared with the case where the vertical positional relationship between the cathode gas flow path 114 and the low-pressure gas flow path 113 is reversed.

In the compression apparatus 200 of this embodiment, as illustrated in FIG. 1A, the remover 300 is disposed on the bottom side of the electrochemical hydrogen pump 100 in the vertical direction of the compression apparatus 200. The reason for this is as follows.

During the passage of a gas through the low-pressure gas flow path 113 of the remover 300, this gas is humidified by at least one of water vapor or liquid water in the cathode gas that has passed through the water-permeable membrane 115. Therefore, if the remover is disposed on the top side of the electrochemical hydrogen pump 100, it is difficult to provide an outlet of the low-pressure gas at the bottom surface of the second plate 20. Unless the outlet of the low-pressure gas is provided at the bottom surface of the second plate 20, liquid water in the low-pressure gas in the low-pressure gas flow path 113 is unlikely to be smoothly drained, and a pipe through which the low-pressure gas flows may be clogged with liquid water.

However, in the compression apparatus 200 of this embodiment, since the remover 300 is disposed on the bottom side of the electrochemical hydrogen pump 100, the outlet of the low-pressure gas is easily provided at the bottom surface of the second plate 20. When the outlet of the low-pressure gas is provided at the bottom surface of the second plate 20, in the compression apparatus 200 of this embodiment, liquid water in the low-pressure gas in the low-pressure gas flow path 113 can be smoothly drained by the action of gravity.

Although not illustrated here, members and equipment necessary for the hydrogen compression operation of the compression apparatus 200 of this embodiment are provided as appropriate.

For example, the compression apparatus 200 may be provided with a temperature detector that detects the temperature of the electrochemical hydrogen pump 100 and a pressure detector that detects the pressure of the cathode gas containing hydrogen compressed at the cathode CA of the electrochemical hydrogen pump 100.

The compression apparatus 200 of this embodiment may be provided with a hydrogen reservoir (not illustrated) that stores the cathode gas (hydrogen) from which at least one of water vapor or liquid water has been removed in the remover 300. The hydrogen reservoir may be, for example, a hydrogen tank. The cathode gas (hydrogen) in a dry state, the cathode gas being stored in the hydrogen reservoir, is supplied to a hydrogen consumer in a timely manner. The hydrogen consumer may be, for example, a fuel cell.

The configurations of the compression apparatus 200 described above are examples and are not limited to these examples. For example, the compression apparatus 200 of this embodiment employs a dead-end structure in which the whole quantity of hydrogen (H₂) in the hydrogen-containing gas supplied to the anode AN is compressed at the cathode CA, Alternatively, the compression apparatus 200 may employ a recycle structure in which part of the hydrogen-containing gas supplied to the anode AN is discharged to the outside.

The hydrogen-containing gas may be, for example, pure hydrogen gas or a gas having a lower hydrogen concentration than pure hydrogen gas. The latter hydrogen-containing gas may be, for example, a hydrogen gas produced by electrolysis of water or a reformed gas that contains hydrogen.

### First Example

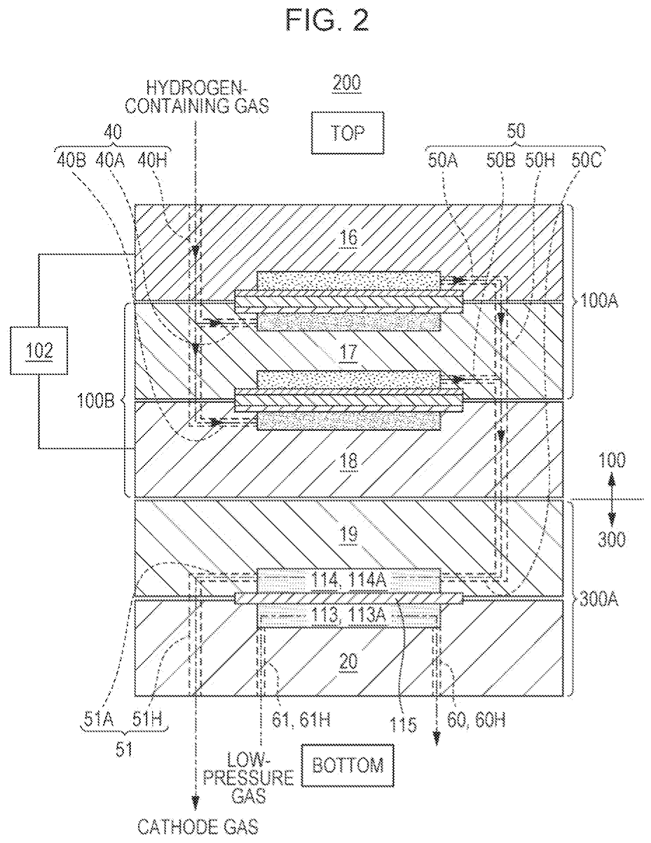

FIG. 2 is a view illustrating an example of a compression apparatus in First Example according to the first embodiment.

A compression apparatus 200 of this Example is the same as the compression apparatus 200 according to the first embodiment except that a first porous member 114A is disposed in the cathode gas flow path 114 of the remover 300 and a second porous member 113A is disposed in the low-pressure gas flow path 113 of the remover 300. The first porous member 114A may be disposed in the cathode gas flow path 114 of the remover 300 so as to be in contact with the water-permeable membrane 115 of the remover 300. The second porous member 113A may be disposed in the low-pressure gas flow path 113 of the remover 300 so as to be in contact with the water-permeable membrane 115 of the remover 300.

The first porous member 114A desirably has elasticity so as to appropriately follow the displacement or deformation of the water-permeable membrane 115 caused by the differential pressure between the cathode gas flow path 114 (high pressure) and the low-pressure gas flow path 113 (low pressure) of the remover 300. For example, the first porous member 114A may be formed of an elastic body including carbon fibers. Such an elastic body may be, for example, carbon felt in which carbon fibers are stacked, The first porous member 114A may include the cathode gas diffusion layer 14.

The second porous member 113A desirably has high rigidity and can reduce the displacement or deformation of the water-permeable membrane 115 caused by the differential pressure between the cathode gas flow path 114 (high pressure) and the low-pressure gas flow path 113 (low pressure) of the remover 300. For example, the second porous member 113A may be composed of a metal. The second porous member 113A composed of a metal may be, for example, a metal sintered body. Examples of the metal sintered body include sintered bodies of a metal powder composed of stainless steel or titanium and sintered bodies of metal fibers composed of any of these materials. The second porous member 113A may include the anode gas diffusion layer 15.

Thus, the removal unit 300A may be constituted by the same cell structure as each of the hydrogen pump unit 100A and the hydrogen pump unit 100B.

Next, a description will be made of the operation and effect of the compression apparatus 200 of this Example in which the first porous member 114A is disposed in the cathode gas flow path 114 of the remover 300.

Unless the first porous member 114A is disposed in the cathode gas flow path 114 of the remover 300, the flow of the cathode gas in this cathode gas flow path 114 tends to be a laminar flow. In this case, at least one of water vapor or liquid water in the cathode gas flows together with the cathode gas. Therefore, for example, at least one of water vapor or liquid water in the cathode gas present at a position apart from the water-permeable membrane 115 is less likely to come in contact with the water-permeable membrane 115. That is, in this case, at least one of water vapor or liquid water that passes through the water-permeable membrane 115 may be limited to at least one of water vapor or liquid water in the cathode gas flowing near the main surface of the water-permeable membrane 115.

In contrast, in the compression apparatus 200 of this Example, the first porous member 114A disposed in the cathode gas flow path 114 can forcibly change the flow of the cathode gas in the cathode gas flow path 114 in random directions, In this case, at least one of water vapor or liquid water in the cathode gas present at various positions in the cathode gas flow path 114 can come in contact with the water-permeable membrane 115. Thus, in the compression apparatus 200 of this Example, at least one of water vapor or liquid water in the cathode gas is more likely to come in contact with the water-permeable membrane 115 than the case where the first porous member 114A is not disposed in the cathode gas flow path 114. When at least one of water vapor or liquid water in the cathode gas comes in contact with the water-permeable membrane 115, at least one of high-pressure water vapor or liquid water that comes in contact with the water-permeable membrane 115 can be efficiently passed into the low-pressure gas that comes in contact with the water-permeable membrane 115 through the water-permeable membrane 115 by the differential pressure between the cathode gas flow path 114 (high pressure) and the low-pressure gas flow path 113 (low pressure) of the remover 300. This enables the removal of at least one of water vapor or liquid water in the cathode gas to be accelerated in the remover 300.

If the first porous member 114A is not provided so as to be in contact with the water-permeable membrane 115, the cathode gas easily passes through the gap between the first porous member 114A and the water-permeable membrane 115. Consequently, for example, in the case where the size of the gap is changed by the magnitude of the differential pressure between the cathode gas flow path 114 (high pressure) and the low-pressure gas flow path 113 (low pressure) of the remover 300, the flow state of the cathode gas changes in the cathode gas flow path 114. Since this affects water permeability in the water-permeable membrane 115, it becomes difficult to stably remove at least one of water vapor or liquid water in the cathode gas. However, this problem is alleviated in the compression apparatus 200 of this Example because the contact interface between the first porous member 114A and the water-permeable membrane 115 can be stably maintained by providing the first porous member 114A so as to be in contact with the water-permeable membrane 115.

Furthermore, in the compression apparatus 200 of this Example, when the first porous member 114A is disposed so as to be in contact with the water-permeable membrane 115, the first porous member 114A functions as a heat conductor for cooling the cathode gas flowing through the cathode gas flow path 114. Accordingly, the cathode gas is effectively cooled when the cathode gas passes through the cathode gas flow path 114. This enables the compression apparatus 200 of this Example to accelerate the production of condensed water from water vapor in the cathode gas compared with the case where the first porous member 114A is not provided so as to be in contact with the water-permeable membrane 115 in the remover 300.

Next, a description will be made of the operation and effect of the compression apparatus 200 of this Example in which the second porous member 113A is disposed in the low-pressure gas flow path 113 of the remover 300.

Unless the second porous member 113A is disposed in the low-pressure gas flow path 113 of the remover 300, the water-permeable membrane 115 is deformed by the differential pressure between the cathode gas flow path 114 (high pressure) and the low-pressure gas flow path 113 (low pressure) of the remover 300 in a direction in which the low-pressure gas flow path 113 is clogged. For example, such a differential pressure may cause the water-permeable membrane 115 to come in contact with a member of the remover 300, the member constituting the low-pressure gas flow path 113. Consequently, the flow of the gas in the low-pressure gas flow path 113 may become difficult. However, this problem is alleviated in the compression apparatus 200 of this Example because the second porous member 113A is disposed in the low-pressure gas flow path 113. The water that has passed through the water-permeable membrane 115 can be efficiently drained, through pores of the second porous member 113A, to the outside of the remover 300 together with the gas in the low-pressure gas flow path 113.

If the second porous member 113A is not disposed so as to be in contact with the water-permeable membrane 115, for example, bending stress on the water-permeable membrane 115 due to the differential pressure between the cathode gas flow path 114 (high pressure) and the low-pressure gas flow path 113 (low pressure) of the remover 300 may be generated at an edge portion of a member of the remover 300, the member constituting the low-pressure gas flow path 113. Consequently, the water-permeable membrane 115 may be broken by such bending stress. However, this problem is alleviated in the compression apparatus 200 of this Example because the second porous member 113A is disposed so as to be in contact with the water-permeable membrane 115.

If the second porous member 113A is not disposed so as to be in contact with the water-permeable membrane 115, for example, the low-temperature gas easily passes through the gap between the second porous member 113A and the water-permeable membrane 115.

Consequently, for example, in the case where the size of the gap is changed by the magnitude of the differential pressure between the cathode gas flow path 114 (high pressure) and the low-pressure gas flow path 113 (low pressure), the flow state of the gas changes in the low-pressure gas flow path 113. Since this affects water permeability in the water-permeable membrane 115, it becomes difficult to stably remove at least one of water vapor or liquid water in the cathode gas. However, this problem is alleviated in the compression apparatus 200 of this Example because the contact interface between the second porous member 113A and the water-permeable membrane 115 can be stably maintained by disposing the second porous member 113A so as to be in contact with the water-permeable membrane 115.

Next, a description will be made of the operation and effect of the compression apparatus 200 of this Example in which the second porous member 113A and the first porous member 114A are composed of a metal material and an elastic material, respectively.

In the compression apparatus 200 of this Example, when the second porous member 113A is composed of a metal material, rigidity of the second porous member 113A can be appropriately ensured. Consequently, since the deformation of the water-permeable membrane 115 due to the differential pressure between the cathode gas flow path 114 (high pressure) and the low-pressure gas flow path 113 (low pressure) is unlikely to occur, the contact interface between the second porous member 113A and the water-permeable membrane 115 and the contact interface between the first porous member 114A and the water-permeable membrane 115 can be stably maintained. This enables the compression apparatus 200 of this Example to stabilize the removal of at least one of water vapor or liquid water in the cathode gas.

In the compression apparatus 200 of this Example, when the first porous member 114A is composed of an elastic material, elastic deformation of the first porous member 114A can be appropriately generated. Accordingly, even when a differential pressure is generated between the cathode gas flow path 114 (high pressure) and the low-pressure gas flow path 113 (low pressure) of the remover 300, the contact interface between the first porous member 114A and the water-permeable membrane 115 can be stably maintained.

For example, when the water-permeable membrane 115 is deformed by the generation of the differential pressure in a direction in which the low-pressure gas flow path 113 is clogged, it is difficult to stably maintain the contact interface between the first porous member 114A and the water-permeable membrane 115. Consequently, since this affects water permeability in the water-permeable membrane 115, it becomes difficult to stably remove at least one of water vapor or liquid water in the cathode gas, as described above. However, in the compression apparatus 200 of this Example, when the first porous member 114A is composed of an elastic material, the elastic deformation of the first porous member 114A can follow the deformation of the water-permeable membrane 115 in a direction in which the contact between the first porous member 114A and the water-permeable membrane 115 is maintained. For example, when the first porous member 114A is accommodated in the recess of the first plate 19, it is preferable to compress the first porous member 114A in advance by an amount greater than or equal to the amount corresponding to the deformation of the water-permeable membrane 115.

The compression apparatus 200 of this Example may be the same as the compression apparatus 200 according to the first embodiment except for the features described above.

### Second Example

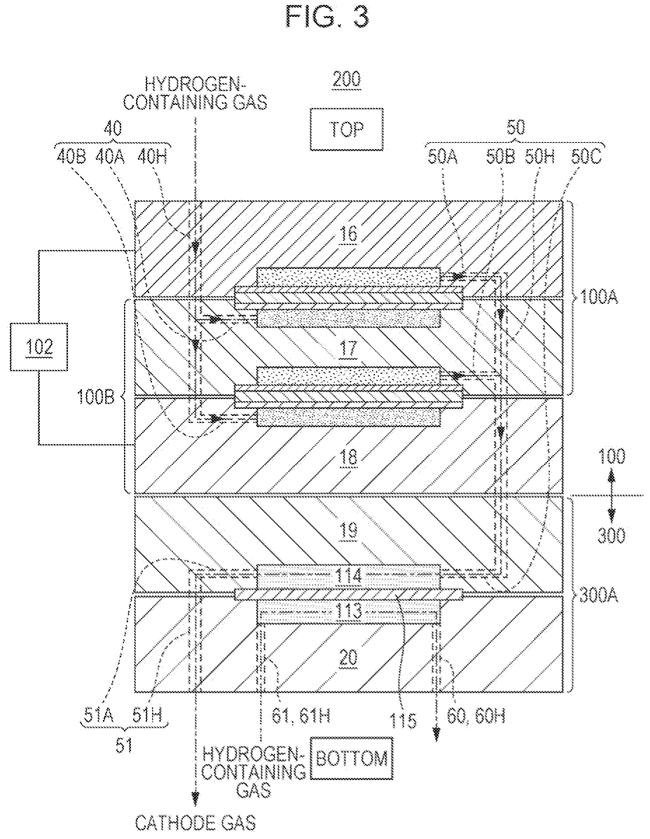

FIG. 3 is a view illustrating an example of a compression apparatus in Second Example according to the first embodiment.

A compression apparatus 200 of this Example is the same as the compression apparatus 200 according to the first embodiment except that the low-pressure gas that flows into the low-pressure gas flow path 113 of the remover 300 is a hydrogen-containing gas.

The hydrogen-containing gas may be, for example, pure hydrogen gas in a dry state or a gas in a dry state, the gas having a lower hydrogen concentration than pure hydrogen gas. The temperature of this hydrogen-containing gas is preferably lower than the temperature of the cathode gas flowing into the cathode gas flow path 114 of the remover 300.

Thus, in the compression apparatus 200 of this Example, when a hydrogen-containing gas that flows out from the cathode gas flow path 114 of the remover 300 is supplied to the anodes AN of the electrochemical hydrogen pump 100, the hydrogen-containing gas can be humidified in the remover 300.

The low-pressure gas that flows into the low-pressure gas flow path 113 of the remover 300 is not necessarily a hydrogen-containing gas. For example, the low-pressure gas may be air in a dry state. This reduces the necessity of a special post-treatment for the gas discharged from the remover 300.

The compression apparatus 200 of this Example may be the same as the compression apparatus 200 according to the first embodiment or the compression apparatus 200 in First Example except for the features described above,

### Second Embodiment

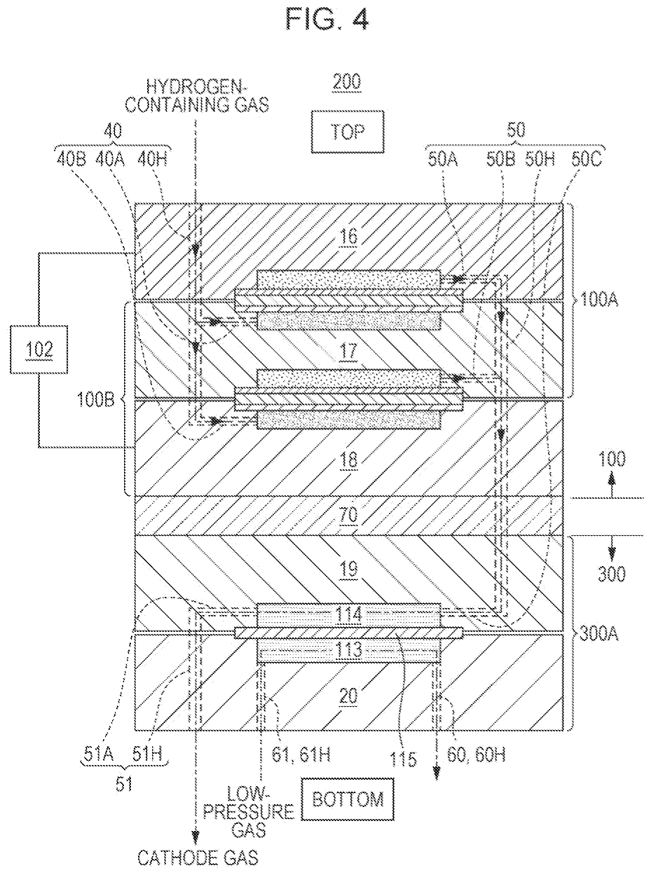

FIG. 4 is a view illustrating an example of a compression apparatus according to a second embodiment.

In the example illustrated in FIG. 4, a compression apparatus 200 includes an electrochemical hydrogen pump 100, a remover 300, a voltage applicator 102, and a heat-insulating member 70.

Here, since the electrochemical hydrogen pump 100, the remover 300, and the voltage applicator 102 are the same as those of the first embodiment, a description thereof is omitted.

The heat-insulating member 70 is disposed between the electrochemical hydrogen pump 100 and the remover 300. In the compression apparatus 200 of this embodiment, the heat-insulating member 70 is disposed between an anode separator 18 of a hydrogen pump unit 1008 and a first plate 19 of a removal unit 300A.

In the electrochemical hydrogen pump 100, the proton conductivity of an electrolyte membrane 11 increases under a condition of high temperature and high humidity (for example, the temperature and the dew point of a hydrogen-containing gas to be supplied to the electrolyte membrane 11 are about 60° C.), and the efficiency of the hydrogen compression operation of the electrochemical hydrogen pump 100 is improved.

In contrast, in the remover 300, for example, the temperature of the low-temperature gas flowing into the low-pressure gas flow path 113 of the remover 300 is made lower than the temperature of the cathode gas flowing into the cathode gas flow path 114 of the remover. Consequently, when the cathode gas passes through the cathode gas flow path 114, the cathode gas is appropriately cooled by heat exchange through the water-permeable membrane 115 between the two gases. Thus, high-pressure condensed water produced by condensation of water vapor in the cathode gas can be efficiently passed into the low-pressure gas through the water-permeable membrane 115 by the differential pressure between the cathode gas flow path 114 (high pressure) and the low-pressure gas flow path 113 (low pressure).

In the compression apparatus 200 described above, if the electrochemical hydrogen pump 100 and the remover 300 are provided as a single body without disposing the heat-insulating member 70 between the electrochemical hydrogen pump 100 and the remover 300, the temperature of the hydrogen pump unit 100B of the electrochemical hydrogen pump 100 may become lower than a desired temperature due to heat exchange between the hydrogen pump unit 100B and the remover 300. Alternatively, the temperature of the remover 300 may become higher than a desired temperature due to heat exchange between the hydrogen pump unit 100B and the remover 300.

In view of the above, in the compression apparatus 200 of this embodiment, the disadvantages described above can be reduced by disposing the heat-insulating member 70 between the electrochemical hydrogen pump 100 and the remover 300 as illustrated in FIG. 4.

The compression apparatus 200 of this embodiment may be the same as any one of the compression apparatus 200 according to the first embodiment and the compression apparatuses 200 in First Example and Second Example according to the first embodiment except for the features described above.

### Third Embodiment

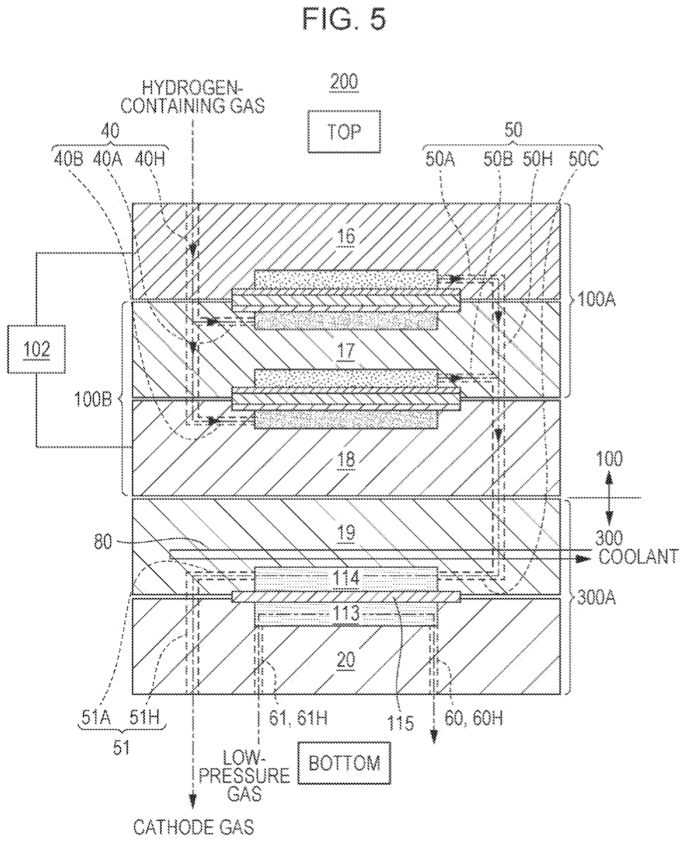

FIG. 5 is a view illustrating an example of a compression apparatus according to a third embodiment.

In the example illustrated in FIG. 5, a compression apparatus 200 includes an electrochemical hydrogen pump 100, a remover 300, a voltage applicator 102, and a cooler 80.

Here, since the electrochemical hydrogen pump 100, the remover 300, and the voltage applicator 102 are the same as those of the first embodiment, a description thereof is omitted.

The cooler 80 is a device that cools a cathode gas flowing through a cathode gas flow path 114 of a removal unit 300A. The cooler 80 may have any configuration as long as the cooler 80 is a device having the above cooling function. The cooler 80 may be, for example, a cooler using a coolant. In this case, for example, a flow path through which the coolant flows is provided as the cooler 80 in a first plate 19. For example, cooling water, antifreeze, or the like can be used as the coolant.

Thus, in the compression apparatus 200 of this embodiment, the removal of water vapor in the cathode gas can be accelerated by cooling the cathode gas in the remover 300 with the cooler 80. For example, the amount of saturated water vapor contained in the cathode gas decreases with the decrease in the temperature of the cathode gas. Therefore, when the amount of water vapor in the cathode gas is the amount of saturated water vapor, a decrease in the temperature of the cathode gas with the cooler 80 enables a rapid decrease in the amount of water vapor in the cathode gas. This enables the removal of water vapor in the cathode gas to be accelerated. In this case, since the amount of liquid water present in the remover 300 increases, the liquid water is more likely to come in contact with the water-permeable membrane 115. When the liquid water comes in contact with the water-permeable membrane 115, the high-pressure liquid water that comes in contact with the water-permeable membrane 115 can be efficiently passed into the low-pressure gas through the water-permeable membrane 115 by the differential pressure between the cathode gas flow path 114 (high pressure) and the low-pressure gas flow path 113 (low pressure) of the remover 300.

The compression apparatus 200 of this embodiment may be the same as any one of the compression apparatus 200 according to the first embodiment, the compression apparatuses 200 in First Example and Second Example according to the first embodiment, and the compression apparatus 200 according to the second embodiment except for the features described above.

The first embodiment, First Example and Second Example in the first embodiment, the second embodiment, and the third embodiment may be combined with each other as long as they do not exclude each other.

From the foregoing description, many modifications and other embodiments of the present disclosure will be apparent to those skilled in the art. Therefore, the foregoing description is to be construed as illustrative only and is provided to teach those skilled in the art the best mode for carrying out the present disclosure. The operating conditions, compositions, structures, and/or functions can be substantially changed without departing from the spirit of the present disclosure.

One aspect of the present disclosure can be utilized in, for example, a compression apparatus that can more simply constitute a remover that removes at least one of water vapor or liquid water in a cathode gas containing hydrogen compressed in a compressor than in the related art.

What is claimed is:

1. A compression apparatus comprising:
a compressor that includes an electrolyte membrane, an anode catalyst layer disposed on a first main surface of the electrolyte membrane, a cathode catalyst layer disposed on a second main surface of the electrolyte membrane, an anode gas diffusion layer disposed on the anode catalyst layer, a cathode gas diffusion layer disposed on the cathode catalyst layer, and a voltage applicator that applies a voltage between the anode catalyst layer and the cathode catalyst layer, in which application of the voltage by the voltage applicator causes movement of, through the electrolyte membrane onto the cathode catalyst layer, a proton extracted from an anode fluid that has been supplied onto the anode catalyst layer, to produce compressed hydrogen; and
a remover that includes a water-permeable membrane, a first flow path which is disposed on a first main surface of the water-permeable membrane and through which a cathode gas discharged from the compressor flows, and a second flow path which is disposed on a second main surface of the water-permeable membrane and through which a gas at a lower pressure than the cathode gas flows, the remover removing at least one of water vapor or liquid water contained in the cathode gas flowing through the first flow path,
wherein the compressor and the remover are provided as a single body.

2. The compression apparatus according to claim 1, wherein a first porous member is disposed in the first flow path.

3. The compression apparatus according to claim 1, wherein a second porous member is disposed in the second flow path.

4. The compression apparatus according to claim 2, wherein the first porous member includes the cathode gas diffusion layer.

5. The compression apparatus according to claim 3, wherein the second porous member includes the anode gas diffusion layer.

6. The compression apparatus according to claim 1, wherein in the remover, the first flow path is disposed so as to be located above the second flow path.

7. The compression apparatus according to claim 1, wherein the remover is disposed on a bottom side of the compressor.

8. The compression apparatus according to claim 1, comprising a heat-insulating member between the compressor and the remover.

9. The compression apparatus according to claim 1, wherein the gas at the lower pressure is a hydrogen-containing gas.

10. The compression apparatus according to claim 1, comprising a cooler that cools the cathode gas flowing through the first flow path.

11. The compression apparatus according to claim 1, wherein the remover is stacked with respect to the compressor in the same direction as a direction in which the anode gas diffusion layer, the anode catalyst layer, the electrolyte membrane, the cathode catalyst layer, and the cathode gas diffusion layer in the compressor are stacked.
